(19) United States
(12) Patent Application Publication
(10) Pub. No.: US 2002/0108071 A1
(43) Pub. Date: Aug. 8, 2002

(54) Consistent assignment of unambiguous indices to objects

(75) Inventor: Marcus Lowell Munger, Boulder, CO (US)

Correspondence Address: Carl M. Wright, 646 Furman Way, Boulder, CO, 80305-5614, US

(73) Assignee: Lockheed Martin Corporation

(21) Appl. No.: 09/733,578

(22) Filed: Dec. 8, 2000

(51) Int. Cl. H04L 1/22

(52) U.S. Cl. 714/1

(57) ABSTRACT

Consistent and unambiguous pattern sorting and assignment of indices to clustered K objects in a multidimensional space. The dispersion along each dimension is calculated and the order of dimensions by which the sort sequence is arranged corresponds to the inverse order of the dispersion values. For each dimension, unsorted objects are grouped and arranged according to coordinate values. The sort sequence, i.e., assignment of indices, is performed by comparing the coordinate value in successive dimensions of each object with its successor or its predecessor. If the magnitudes of the differences are less than one or more predetermined thresholds, the points are transferred to another array which is sorted along the next dimension. The groupings and index assignments continue until all objects have been assigned an index.

### CROSS-REFERENCE TO RELATED APPLICATIONS

This application is related to copending patent application [Docket No. MG-00067] filed concurrently herewith.

### GOVERNMENT RIGHTS IN THE INVENTION

The United States Government has rights in this invention pursuant to Contract No. F04701-96-C-0044 with the Department of the Air Force.

### BACKGROUND OF THE INVENTION

1. Field of the Invention

The invention relates to the assignment of unique identifiers or indices to a plurality of objects in an n-dimensional space. Particularly, it relates to an assignment schema that assigns the identifiers or indices unambiguously in a consistent manner, especially where there are a plurality of successive assignments of indices to variations in the pattern of the objects, e.g., in successive time-separated observations.

2. Background

A common problem in multiple target tracking is the identification of individual targets in a cluster of targets. This is particularly true when the cluster is not observed continuously. In scanning or staring sensors, the cluster is observed momentarily. The time interval between observations may be long and the motion of clusters is fast enough that the error in prediction of the target's positions is greater than the separation of the targets in the cluster.

It is often necessary to assign indices to objects so that all the observations are in the K same relative order as closely as possible. Furthermore, if additional noise or background observations are added or some of the objects do not appear during successive observations, the relative order must still be maintained to the maximum extent possible. By relative order is meant that if an object oᵢ is indexed ahead of object oⱼ in one cluster, object oᵢ will likely be indexed ahead of oⱼ in subsequent clusters.

Applications of the invention include object identification in aerial surveys and sorting multiple targets as in a ground-controlled radar approach system.

### BRIEF SUMMARY OF THE INVENTION

In accordance with the invention, a method of assigning identifying indicia to objects in a multidimensional space includes arranging the objects initially according to a first dimension of their location in the multidimensional space and grouping subsets of objects according to any ambiguities in the arrangement. Unsorted objects, i.e., having no index assigned, are ordered in subsets according to other dimensions of the multidimensional space. The first dimension is preferably that along which separation of objects exhibits the greatest dispersion. If the coordinate in the dimension is substantially equal to that of another object, no index is assigned to one of them according to one of several approaches. The process is complete when all objects have been assigned an index.

### BRIEF DESCRIPTION OF THE FIGURES OF THE DRAWING

The invention is described in detail by referring to the various figures of the drawing which illustrate specific embodiments of the invention, and wherein like numerals refer to like elements.

FIG. 1 is an illustration of seven points showing the general problem solved by the invention.

FIG. 2 is a flowchart of a preliminary part of the implementation of the invention.

FIG. 3 is a flowchart of an ASSIGN subroutine embodying the invention.

### DETAILED DESCRIPTION OF THE INVENTION

One of the difficult problems in tracking closely spaced objects is to correlate observed objects with tracks. A track is defined as a collection of all observations of a single object. A pattern sorting algorithm is disclosed to order all the observations for each of several observations (snapshots) of all the objects in a consistent manner. Also, for purposes of explanation, the coordinate directions (dimensions) are written in upper case, e.g., as X1 and X2, and the measurements along the axes in lower case as x₁ and x₂. The points are denoted as Pn or Pn(x₁,x₂, . . . ,xₘ) where m is the number of dimensions involved and x₁ is the value of the i-th coordinate in dimension Xi. The index assigned to point Pj is denoted by #Pj.

The invention will be explained using an example of the problem which the invention is directed to solving, viz., the consistent assignment of unambiguous indices to a plurality of points in a multidimensional space. An illustrative example is shown in FIG. 1 which depicts seven points in a three-dimensional space. The axes are X1, X2, and X3. (These are commonly referred to as the x-, y-, and z-axes but the more generalized reference will be used for consistency since there are situations where more than three dimensions may be required.)

Sensing devices have known error distributions. For example, in a passive sensor array comprising a plurality of elements, a known error of measurement is associated in both the horizontal and vertical directions. Therefore, each dimension is assigned a threshold value. Where the objects are maneuvering targets, two thresholds may be assigned. The first could be a jitter threshold based on the measurement errors of the system. These errors are known to the user and vary widely depending on the sensors and processors used in a particular sensor. A threshold of 3.5σₑ, i.e., related to the standard deviation of the measurement error, should sort the points correctly 99.7-percent of the time. For purposes of illustration in the following example, the thresholds are taken as zero. In practice, the thresholds would be determined depending on the nature of the system.

The second threshold can be derived from the motion of the objects from one observation to another. The two thresholds can be combined into a single threshold in a statistical manner.

The points can be initially numbered in any convenient order, in this case from the top toward the bottom, i.e., in descending order along the z-axis. The points located in the three-dimensional space of FIG. 1 are: P0(2,1,8), P1(1,1,5), P2(2,1,5), P3(3,1,5), P4(2,3,5), P5(2,1,2), and P6(1,1,2). If the points are sorted (and assigned indices) along the X1 axis, the points P0, P2, P4, and P5 would be ambiguous as would points P1 and P6 since both sets have the same x₁ value. Similarly, sorting along the X2 axis creates an ambiguity among the points P0, P1, P2, P3, P5, and P6 since all have an x₂ value of 1. Along the X3 axis, the points P1, P2, P3, and P4 have the same x₃ value as do points P5 and P6.

In situations such as described in copending patent application [Docket No. MG-00067], it is essential to assign indices in a consistent manner so as to correlate points from one varying pattern to another. Although some points may change position from one pattern to another, e.g., in time-varying observations, a consistent system of index assignment aids the correlation of points using the technique disclosed in copending patent application [Docket No. MG-00067].

The technique to be described in detail is preferably practiced by sorting the points along the various dimensions in the order according to their distribution in descending order of their dispersion. That is, the first dimension in the sort order is the dimension exhibiting the largest dispersion. Various measures of dispersion are available. The one used here is the standard deviation (σ) which is usually the most efficient and indicative of the distribution spread of variables. The second threshold could be a motion threshold and taken as the maximum relative speed of one target with respect to any other target.

In the following description, references are made to the flowcharts depicting the sequence of operations performed by the program. The symbols used are standard flowchart symbols accepted by the American National Standards Institute and the International Standards Organization. In the explanation, an operation may be described as being performed by a particular block in the flowchart. This is to be interpreted as meaning that the operations referred to are performed by programming and executing a K sequence of instructions that produces the result said to be performed by the described block. The actual instructions used depend on the particular system used to implement the invention. Different processors have different instruction sets but persons of ordinary skill in the art are familiar with the instruction sets with which they work and can implement the operations set forth in the blocks of the flowchart.

The preliminary procedures for sorting (and assigning indices to) the points are to set up the data, i.e., the points, and to determine the order of sorting and threshold values for each dimension. The assignment of indices is then performed. A pseudo-code listing below shows the basic steps. The total number of points is n and the number of dimensions is m. In the illustrative example, n=7 and m=3 and the procedure is recursive.

Setup array of points with #P=0

Calculate statistics for each dimension and set J sort order

Set up threshold values for each dimension Tj

```
Index = 1
Call ASSIGN
Subroutine ASSIGN
If no open points
    Return
Sort J-array
Set i = 0
—Loop:
Move P[i] to J+1−array
k = 1
While |x[i,j] − x[i+1,j]| < Tj
    Move P[i+1] to J+1−array
    i = i + 1
    k = k + 1
If k = 1
    Assign Index to P[k,j+1]
    i + 1
Else
    If J = m
        Force Assignment
        Go to EndTest
    Else
        J = next J
        Call ASSIGN
        J = previous J
—EndTest:
    If i > k
        Return
    Else
        Go to Loop
```

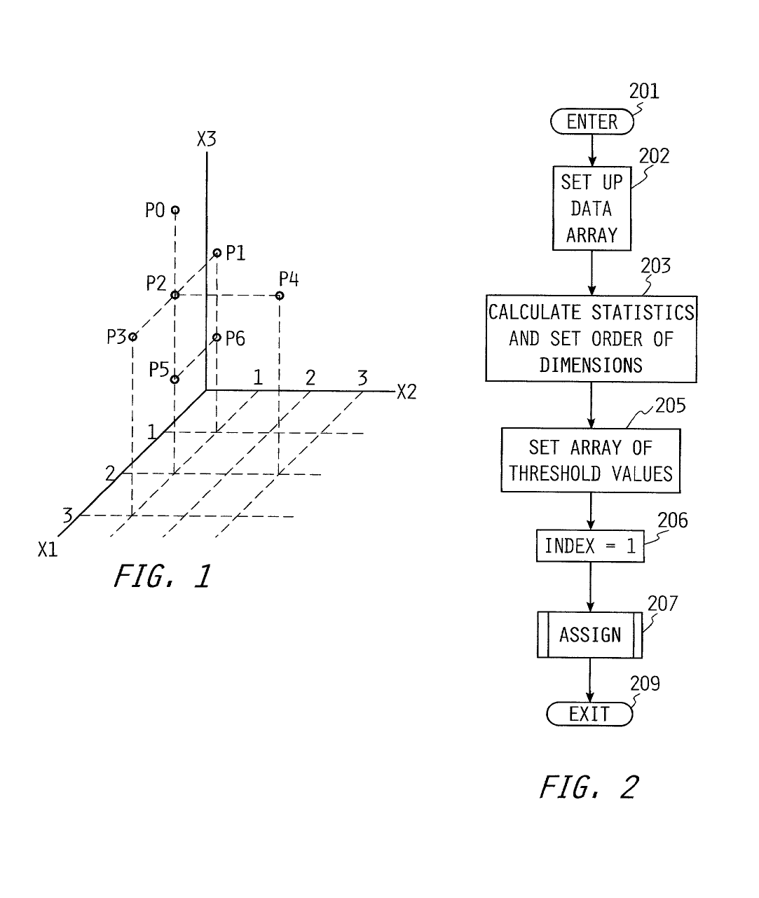

A flowchart for the preliminary steps in practicing the invention is set forth in FIG. 2. The process begins when it is entered via a terminal block 201. First, in a process block 202, the data array is setup. This is a table, list, or other collection of the objects together with their parameters including the coordinate values along the applicable dimensions. The index value for each point is initially set to zero. This provides a basis for determining which points remain to be processed. For example, the index of each point can be sensed and if none are zero, the assignment is completed.

The successive values of J are the dimensions on which the successive sort criteria are based. The order of sorting for the present J-array is determined at a process block 203. The order of the dimensions in which the points are to be processed are determined from the statistics of the spread of the objects' locations along each dimension. The order of processing the dimensions should be along those which exhibit the greater dispersion, e.g., having the larger standard deviations among the points.

The threshold values for each dimension are set up in an array in a process block 205. The index value is then initialized to 1 in a process block 206. A subroutine ASSIGN is called as shown in block 207. When the program has completed execution of the ASSIGN subroutine, the process is exited via a terminal 209.

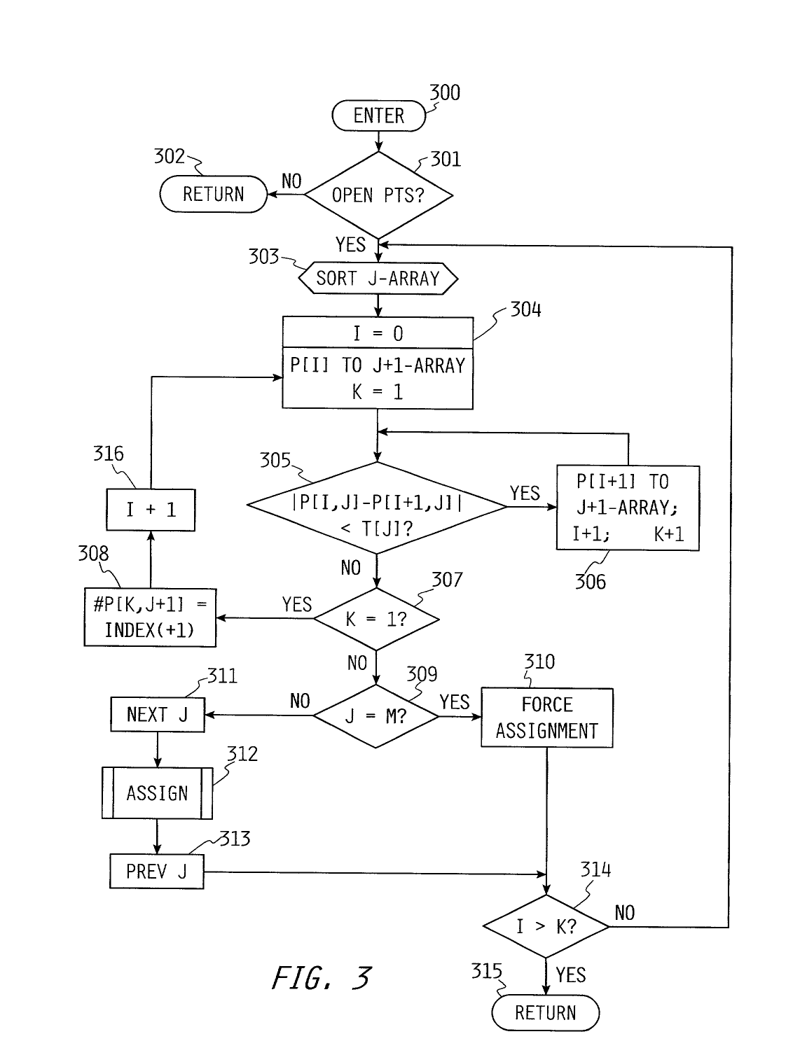

FIG. 3 is a flowchart for the ASSIGN subroutine. It starts at a terminal 300 when called by the main program. The subroutine first checks, in a decision block 301, whether there are any open points, i.e., whether there are points that have not been assigned an index. One approach is to ascertain whether the value of the index is greater than n, the total number of points. Another approach is to determine whether any point's index remains an initially assigned value of zero.

The J-array is then sorted in a process block 303. Once the J-array is in the order according to the dimension J, a list pointer I is set to 0, the point P[I] is moved to a J+1-array, and a count K is set to 1. The K count is the number of points which have been moved into the J+1-array.

Next, the J-th coordinate of the point P[I+1] is compared to the J-th coordinate of the point P[I]. If the magnitude (absolute value) of the difference between them is less than the J-th threshold, T[J], as determined in a decision block 304, then the point P[I=1] is moved into the J+1-array and the values of I and K are incremented in a process block 306. When the magnitudes of difference between successive points is not less than the threshold, the value of K is tested by a decision block 307. If K=1, only one point has been moved to the J+1-array and therefore no ambiguity exists with respect to other points. The present value of the index is assigned to the point and the index value is incremented as denoted by (+1) in a process block 308. The value of I is incremented in a block 316 and the process continues by moving the next P[I] to the J+1-array.

If, at the decision block 307, K is not equal to 1, then the J+1-array contains K points having the same xⱼ value, i.e., are ambiguous. A check is made at a decision block 309 to determine whether all the dimensions have been processed. If so, then at a process block 310, the assignment of the indices of the points in the array is forced. One forced assignment method is to allocate the indices in the order in which the points appear in the array.

At a decision block 314, the value of I is compared to K to ascertain whether all the points in the J-array have been processed. If so, the return at a terminal block 315 is executed. If not, the process continues at the block 303 and proceeds as described above.

If additional dimensions are to be processed, then at a process block 311, J is replaced by the next dimension. The subroutine block 312 indicates that the subroutine ASSIGN is called. Calling a subroutine from within the subroutine itself is termed reentrant and permits recursive processing. Recursive processing can be converted to reiterative processing using known techniques. For example, the call to the subroutine is replaced by pushing the local variables and return addresses onto a stack, pushing the present address onto the stack, and branching to the beginning of the subroutine. The return in the recursive version is replaced by executing a normal return if the stack is empty or, if the stack is not empty, popping the return address from the top of the stack, popping all the local variables and parameters and assigning them to their corresponding variables and parameters, and then branching to the popped return address. Alternatively, pointers to the variables, i.e., their memory location addresses, can be pushed onto and popped from a stack.

When all the points in the array being processed have been indexed, J is replaced by the previous value in a process block 313 and the test for the J-array (where J is now the previous J when the subroutine was reentered) is made to determine whether it contains any unprocessed points. In reentrant programs, the local variables (such as I and K in this case) are not the same in each of the re-entries into the subroutines being recursively processed unless assigned globally. Also, the return from the terminal 313 is to the calling program, in this case to the process block 313 if the subroutine were called from within the subroutine.

In one implementation, the first of a group of ambiguous points can be assigned the current index value and the remaining ambiguous points of the groups gathered into an array, sorted according to the next dimension, and assigned indices accordingly. It is possible, however, that the next time the pattern is processed, the input order may have changed. This would result in a different first point of an ambiguous group being assigned the next index value which would create a less consistent assigment. By recursively processing the arrays of ambiguous points, the points are indexed most consistently.

The exemplary points of FIG. 1 will now be processed in accordance with the invention. The original (J=0) array is, where the number in square brackets is the point's index and the xⱼ, x₂, and x₃ coordinates are in parentheses:

P0[0](2,1,8)

P1[0](1,1,5)

P2[0](2,1,5)

P3[0](3,1,5)

P4[0](2,3,5)

P5[0](2,1,2)

P6[0](1,1,2)

The statistics (mean and standard deviation) of the points:

μ₁=1.857; μ₂=1.286; μ₃=4.572;

σ₁=0.690; σ₂=0.756; σ₃=2.070.

Therefore, the J-values are in the sequence 3, 2, and 1. The first sort is along the X3 axis followed by the X2 and X1 axes. As shown above, the original array, now the 3-array, is already sorted in descending order by x₃ since the preliminary assignment of point identifiers was arbitrarily made along the X3 axis from the top down.

The point P0 is moved to the 2-array and K is set to 1. Since ¦x_{3,0}−x_{3,1}¦>0, the point P0 is assigned the index 1 and the index value is incremented to 2. The 3-array is now:

P0[1](2,1,8)

P1[0](1,1,5)

P2[0](2,1,5)

P3[0](3,1,5)

P4[0](2,3,5)

P5[0](2,1,2)

P6[0](1,1,2).

The point P1 is now moved to a new 2-array and K is set to 1. Since ¦x_{3,1}−x_{3,2}¦=0, the point P2 is moved to the 2-array. Similarly, points P3 and P4 are moved to the 2-array. The 2-array is:

P1[0](1,1,5)

P2[0](2,1,5)

P3[0](3,1,5)

P4[0](2,3,5)

Since K is greater than I and all the dimensions have not been processed, the subroutine ASSIGN is called. The 2-array is sorted to

P4[0](2,3,5)

P1[0](1,1,5)

P2[0](2,1,5)

P3[0](3,1,5).

The point P4 is moved to the 1-array (since X1 is the next array in the sort order according to the statistics of the 2-array). The value of K is set to 1. The magnitude of the difference between x_{4,1} and x_{4,2} is greater than 0 so the point P4 is assigned an index of 2 and the index value is incremented to 3.

The point P1 is then moved to the now-empty 1-array and K set to 1. Since the magnitudes of the differences between the next pairs of the x_{•,2} values are 0, the points P2 and P3 are also moved to the 1-array and sorted. The order of the points in the 1-array is P3, P4, and P1. Since the magnitudes of the differences along the X1 axis are greater than zero, they will each be assigned an index. The assignments of indices are made in the order of the sort so that P3 is assigned the index 3, the point P2 is assigned the index 4, and the point P1 is assigned the index 5. The index value now has the value of 6 from the successive increments.

Next, the return from the subroutine is executed. Since it was called from within the subroutine itself, the return next drops back to the previous J-array, that is, the 3-array. Because of the mesne assignments, the 3-array is now:

P0[1](2,1,8)

P1[5](1,1,5)

P2[4](2,1,5)

P3[3](3,1,5)

P4[2](2,3,5)

P5[0](2,1,2)

P6[0](1,1,2).

The point P5 is moved to the 2-array and so is P6 since the magnitudes of the differences between the x₃ values are zero. The statistics indicate that the 2-array should be sorted along the X1 axes. Since the x₁ values are different, the points are assigned the indices 6 for P5 and 7 for P6. The final result is:

P0[1](2,1,8)

P1[5](1,1,5)

P2[4](2,1,5)

P3[3](3,1,5)

P4[2](2,3,5)

P5[6](2,1,2)

P6[7](1,1,2).

While the invention has been particularly shown and described with reference to a preferred embodiment thereof it will be understood by those skilled in the art that various changes and modifications in form and details may be made therein without departing from the spirit and scope of the invention according to the following claims.

What is claimed is:

1. A method of assigning identifying indicia to objects in multidimensional space comprising the steps of:
sorting objects initially according to a first dimension of their location in multidimensional space;
grouping subsets of objects according to ambiguities in the objects; and
ordering ambiguous objects in subsets according to other dimensions of the multidimensional space.

2. The method according to claim 1 wherein said grouping step includes the step of:
determining ambiguities among coordinate values of their location in the multidimensional space according to whether separation of objects in a dimension is less than a predetermined threshold value.

3. The method according to claim 2 wherein said determining step includes the step of
ascertaining a predetermined threshold value based on known errors of position measurements.

4. The method according to claim 1 including an initial step of:
selecting as the first dimension of a multidimensional coordinate system that dimension along which separation of objects exhibits the greatest dispersion.

5. The method according to claim 1 wherein said grouping steps includes the step of:
determining ambiguities among coordinate values according to whether separation of targets is less than any of a plurality of predetermined threshold values.

6. The method according to claim 2 wherein said determining step includes the step of:
ascertaining a predetermined threshold value based on a maximum rate of change of position of one target with respect to any other.

7. The method according to claim 5 wherein said determining step includes the steps of:
ascertaining one of said predetermined threshold values based on maximum rate of change of position of one object with respect to any other; and
ascertaining another one of said predetermined threshold values based on the random errors of measurements in positions of the objects.

8. A method of sorting indicia corresponding to objects moving through a multidimensional space comprising the steps of:
scanning the multidimensional space to detect positions of objects therein;
assigning unique indicia to each detected object;
sorting assigned indicia along one coordinate axis of the multidimensional space;
grouping into subsets any indicia exhibiting an ambiguity along the coordinate axis; and
ordering indicia in subsets according to other coordinate axes of the multidimensional space.
